(19) United States
(12) Patent Application Publication
(10) Pub. No.: US 2015/0261924 A1
(43) Pub. Date: Sep. 17, 2015

(54) HEALTHCARE SYSTEM AND METHOD

(71) Applicant: KONINKLIJKE PHILIPS N.V., Eindhoven (NL)

(72) Inventors: Gijs Geleijnse, Geldrop (NL); Aleksandra Tesanovic, Eindhoven (NL); Jan Johannes Gerardus De Vries, Eindhoven (NL)

(21) Appl. No.: 14/434,987

(22) PCT Filed: Oct. 21, 2013
(86) PCT No.: PCT/EP2013/071980

§ 371 Date: Apr. 10, 2015

(30) Foreign Application Priority Data
Oct. 22, 2012 (EP) 12189439.8

(51) Int. Cl. G06F 19/00; G06Q 50/00

(52) U.S. Cl. CPC G06F 19/345; G06F 19/3406; G06Q 50/01

(57) ABSTRACT

The present invention relates to a healthcare system and a corresponding healthcare method. The system comprises a processor and a computer-readable storage medium, wherein the computer-readable storage medium contains instructions for execution by the processor, wherein the instructions cause the processor to perform the steps of obtaining patient activity data descriptive of a physical activity of a patient, for whom a recommendation for a care plan shall be provided, obtaining social support activity data descriptive of a level of interaction of the patient's social network with the patient, and computing recommendations for a care plan for the patient based on the patient activity data and the social support activity data. Further, the present invention relates to a computer-readable non-transitory storage medium and a computer program.

### FIELD OF THE INVENTION

The present invention relates to a healthcare system comprising a processor and a computer-readable storage medium, wherein the computer-readable storage medium contains instructions for execution by the processor. Further, the present invention relates to a healthcare method, a computer-readable non-transitory storage medium and a computer program.

### BACKGROUND OF THE INVENTION

Healthcare IT systems utilizing Clinical Decision Support (CDS) tools have become a leading response to the growing demand for the promotion of standards-based care delivery. CDS tools are important components of clinical Information Technology (IT) systems and may directly improve patient care outcomes and the performance of healthcare organizations.

In this respect, it is of utmost importance to determine an appropriate level of care that is tailored to the patient's needs and abilities. For elements of care that can be properly managed by the patient himself, no expensive facilities and services need to be arranged. However, any assistance in care, that helps to reduce the probability of adverse events and costly re-hospitalizations, should be provided to the patient in a patient specific care plan.

For example, a smooth transition from hospital to home is essential to reduce the amount of avoidable readmissions. To this end, the patient needs to (1) be discharged at the right moment in a stable condition, (2) be educated, as well as his family, and (3) receive a tailored discharge plan. The discharge plan is a care plan which is formulated by the end of a patient's admission. The discharge plan comprises lifestyle advice, follow-up appointments, medications and specific services such as home nurse visits or telehealth monitoring. The level of care for a patient should fit his condition. Obviously, the higher the level of care, the higher the associated costs. However, a too low level of care increases the risk of readmission which, at the end of the day, causes higher overall cost for treatment and impairs the quality of life of the patient.

The tailoring of a discharge plan is currently an art, where the responsible clinicians use their experience and their impression of the patient. By estimating the level of self-care ability of the patient, the need for care arrangement can be assessed, e.g. the level of formal healthcare such as nurse visits, frequency of follow-up appointments, and professional support such as meal support services. There is a need for an evidence-based approach, where decisions about or recommendations for an appropriate, individualized care plan are based on objective, measurable criteria.

WO 2011095949 A1 discloses a system and method for guideline-based discharge planning of the patient from a facility. The system determines whether a patient meets predetermined discharge criteria for discharge from the facility and generates a care plan for the patient based on this analysis.

Nonetheless, there is a need to further improve the generated care plan and to tailor the recommended services to the needs and abilities of the patient.

### SUMMARY OF THE INVENTION

It is an object of the present invention to provide a healthcare system and healthcare method that better assist a clinician or care giver to plan resources and to tailor care of a patient.

In a first aspect of the present invention a healthcare system is presented that comprises a processor and a computer-readable storage medium, wherein the computer-readable storage medium contains instructions for execution by the processor, wherein the instructions cause the processor to perform the steps of:

obtaining patient activity data descriptive of a physical activity of a patient, for whom a recommendation for a care plan shall be provided,

obtaining social support activity data descriptive of a level of interaction of the patient's social network with the patient, and

computing recommendations for a care plan for the patient based on the patient activity data and the social support activity data.

In a further aspect of the present invention a corresponding healthcare method is presented.

In yet other aspects of the present invention, there are provided a computer program which comprises program code means for causing a computer to perform the steps of the healthcare method when said computer program is carried out on a computer, and a computer-readable non-transitory storage medium containing instructions for execution by a processor, wherein the instruction cause the processor to perform the steps of the claimed healthcare method.

Preferred embodiments of the invention are defined in the dependent claims. It shall be understood that the claimed method, computer program, and computer-readable non-transitory storage medium have similar and/or identical preferred embodiments as the claimed system and as defined in the dependent claims.

It is an objective of a care plan to support a patient to attain, maintain or recover optimal health and quality of life. A special type of care plan is the discharge plan which is formulated by the end of the patient's admission to a professional care facility such as a hospital. An optimum care plan is tailored to the patient's needs and abilities. In this respect, a proper care plan addresses the issues in care that cannot be managed by the patient himself, such as meal support or the uptitration or downtitration of medication. For elements that can be properly managed by the patient himself, for example personal hygiene, no presumably expensive facilities or services need to be arranged. As described above, the tailoring of the discharge plan is currently an art, where the responsible clinicians use their experience and their impression of the patient, however, there is a need for an evidence-based approach, where the decisions are based on objective, measurable criteria.

In known healthcare systems, such measurable data is typically obtained by a patient monitor (among other measuring devices and measurements) that measures the vital signs of the patient. In modern hospital IT solutions, the acquired data can be stored in an electronic health record (EHR) along with reports from clinicians or other medical personnel.

In contrast to systems and methods according to the prior art, that focus on obtaining data of the individual patient only, the system and method according to the present invention obtain data relating to the patient and additional data relating to the patient's social network. The patient's social network plays an important role in the well-being of the patient. However, prior art systems fail to obtain measurable data descriptive of a level of interaction of the patient's social network with the patient.

Besides professional care provided by formal care givers, such as clinicians, nurses and other medical personnel, the self-care ability is essential for the recovery and health maintenance of the patient. Apart from the patient's own health condition, the self-care ability greatly dependent on the patient's social network.

The terms “professional care” or “formal care” refer to care provided by professional care givers. The terms “self-care” or “informal care” in this context refer to care provided by the patient himself or by non-professional, informal careers in their social network. The term “self-care of the patient” refers to care that the patient is capable of by himself without any help. The term “self-care of the social network” refers to care provided by non-professional, informal careers such as family, friends and neighbors.

While medication adherence is frequently hard to monitor and issues only arise after discharge, the present invention focuses on two different measurable aspects to determine the ability for self-care: the physical activity of the patient and the level of interaction of the patient's social network with the patient. This can be measured in the hospital or at home or in the entire hospital-to-home care cycle, both at home and in the hospital. It should be noted that home and hospital are two exemplary settings that do not exclude alternative or additional facilities such as an intermediate care, nursing facilities and the like.

The ability of a patient for self-care is affected, for example, by his frailty, mental status and general ability to move about. Since these elements are different in nature and difficult to measure as such in an unobtrusive manner, the present invention uses the amount of physical activity of the patient as an approximation for the self-care ability of the patient himself. Likewise, the ability of self-care offered by the patient's social network is estimated by measuring their activity level or level of interaction with the patient.

The obtained patient activity data is descriptive of a physical activity of the patient. For example, the patient activity data indicates if a person stays in bed all day long, whether the patient can switch to the chair next to the bed by himself, move about the room or even leave the room. Furthermore, the patient activity data can indicate a duration of physical activity and/or an intensity of physical activity of the patient.

The obtained social support activity data is descriptive of a level of interaction of the patient's social network with the patient. The level of interaction of the patient's social network with the patient can, for example, be obtained by measuring the visits in the hospital and/or an activity in the patient's house after discharge. Since the self-care ability of a patient also depends on his mental well-being, any type of interaction of the patient's social network with the patient can contribute. For example, the obtained social support activity data can comprise information about communication, such as phone calls or online-communication, with friends and family who are not able to visit in person. A person with active social contacts is less likely to suffer from depression or anxiety and thus requires a reduced level of care in this respect. Correspondingly, a patient who lives together with his family does probably not require a high level of formal care.

According to the present invention, the obtained patient activity data and the obtained social support activity data are used to assess the self-care ability. Based on the self-care ability, the required level of professional care is assessed, which is further used to compute recommendations for a care plan. The care plan can be a care plan in hospital, a discharge plan and/or a care plan for a home care situation. The care plan can be updated continuously based on new patient activity data and/or social support activity data obtained by the healthcare system. Thus, the healthcare system according to the present invention also estimates the amount of support from non-professional careers that can be expected for the patient. Recommendations for care plan for the patient can be computed based thereon.

For example, in the hospital setting, patients with limited social support activity who are mainly bedridden will receive very intense care. They will also require additional services at home such as meal support. For patients with excellent social support activity, a discharge plan or care plan with less extensive formal care facilities and hence reduced cost—will be computed.

In one aspect, the invention provides a healthcare system. A healthcare system as used herein encompasses an automated system which facilitates the management of a patient care plan. The healthcare system comprises a processor and a computer-readable storage medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, DVD-R or Blu-ray disks. The term computer readable-storage medium also refers to various types of recording media capable of being accessed by the computer device via a network or communication link. For example a data may be retrieved over a modem, over the internet, or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing devices.

In general, the level of interaction of the patient's social network with the patient, comprises physical activity and non-physical activity of at least one person in the patient's social network. In other words, the interaction of the patient with this social network that has an impact on the self-care ability also comprises non-physical activity such as social interactions. Social interactions are important for the patient's well being. For example, regular phone calls or e-mails from a family member that lives at a remote location can have positive impact on the patient's self-care ability even though the person does not provide care in a physical but rather in a psychological way.

However, in a preferred embodiment of the healthcare system according to the present invention, the level of interaction of the patient's social network with the patient comprises a physical activity of at least one person in the patient's social network. For example, a patient who receives frequent visits of family and friends during his stay in the hospital can be expected to have an active social background that can also provide care to him when the patient is discharged from hospital. Hence, there is a decreased probability that this person will need meal support and will probably have a person to take him to the next appointment at the hospital or to a general practitioner.

In an advantageous embodiment, the healthcare system further comprises at least one sensor for monitoring the patient and an environment of the patient. The at least one sensor can be installed in the hospital and/or at home. Alternatively, the patient can carry the sensor, for example in form of a wrist band with an accelerometer, a chest band or integrated into electronic devices such as a mobile phone. Alternative types of sensors include motion or movement sensors, IR-based sensors, radar sensors or a camera operating in the visible or infrared part of the spectrum. Furthermore, a plurality of same or different sensors can be installed to monitor the patient and the environment of the patient. The patient activity data can be obtained from said sensor. Alternatively or in addition to the patient activity data, social support activity data can be obtained from said at least one sensor. In one embodiment, the sensor provides information about the non-physical interaction of the patient's social network with the patient from their communication with the patient.

In an alternative embodiment, the healthcare system further comprises a signal processing unit for extracting the patient activity data and the social support activity data from an output signal of the at least one sensor. For example, the sensor is a video camera. This video camera observes the patient room of the patient in the hospital. Hence, both the patient as well as the visitors are monitored by the same sensor. The signal processing unit analyzes the video stream and identifies the patient, for example as the person lying in bed. The movements of the patient can be analyzed by the signal processing unit to determine a physical activity of the patient. This data is provided to the healthcare system as patient activity data for further processing. In addition to checking the movements of the patient, additional people can be tracked. Hence, it is possible to obtain social support activity data descriptive of a level of interaction of the patient's social network with the patient, for example by analyzing a physical activity of the visitors.

In an embodiment, the instructions further cause the processor to correct and/or augment the patient activity data and/or a social support activity data based on the schedule of the patient. With respect to the example above, not all of the people that have been tracked are necessarily part of patient's social network. For example, a visit of a doctor or appointments with medical personnel do not count towards activity of the patient's social network. Furthermore, the schedule of the patient may also include the visiting hours of the facility. Since visits are only allowed during the visiting hours, the level of interaction of the patient's social network can be corrected for times that are not available for visits. Furthermore, corrections can be applied for time that the patient is away for medical procedures and the like. For example, an appointment for physiotherapy can count towards physical patient activity.

In an embodiment, the instructions further cause the processor to compute a relative patient activity and/or relative social support activity by comparing the patient activity data and/or social support activity data of the patient with patient activity data and/or social support activity from other patients. Both current and past activity data can be used for comparison. This feature is particularly helpful for comparing patients and activity levels with one another, with historic data and/or data from other facilities.

In yet another embodiment, the instructions further cause the processor to dynamically update said recommendations for the care plan. The computed care plan is not static but provides continuous revisions based on changes in the status of the patient. The care plan can be adapted when new patient activity data and/or new social support activity data is obtained. In order to tailor the care plan to the actual condition of the patient, the proposed healthcare system computes recommendations for the care plan based on objective patient activity data and social support activity data. This is particularly helpful, if the self-care ability of the patient and/or the self-care ability of the social network changes over time.

In a further embodiment of the healthcare system, the instructions further cause the processor to compute said recommendations for the care plan based on a trend of obtained patient activity data and/or social support activity data over time.

In another embodiment, the instructions further cause the processor to increase the recommended level of care for the patient if the patient activity data indicates a decreased patient activity and/or if the social support activity data indicates a decreased social support activity. For example, if the obtained social support activity data indicates that the interaction of the patient's social network with the patient decreases, this indicates that the self-care ability of the social network decreases. Hence, the level of professional care provided by professional care givers can be increased to compensate for the decreased self-care ability of the social network. Alternatively, if the patient activity reduces, the level of professional care can be increased. Of course, if the patient activity and/or social support activity increases, the level of professional care can be decreased. Thereby, an optimum level of care can be ensured throughout the patient care cycle, which in consequence reduces the probability of adverse events and reduces readmissions to hospitals.

In an embodiment, the instructions further cause the processor to recommend the scheduling of medical follow-up meetings at times when the patient is known to have a level of social support above or below a threshold available to him. Instead of simply scheduling a follow-up appointment based on a rigid schedule, these appointments can be arranged such that the needs of the patient's social network are also considered. This avoids, for example, that a family member has to take a day off to take the patient to a doctor. Instead, the appointment can be automatically scheduled when an informal care giver typically has time for the patient anyway.

In a further embodiment, the instructions further cause the processor to use a discharge readiness model describing the readiness of a patient for discharge. In addition to obtaining patient activity data and social support activity data, and computing recommendations for a care plan for the patient, a discharge readiness model is taken into account. Thereby, the optimal moment for patient discharge in view of the self-care ability of the patient and his social network can be included in the care plan. A patient with strong self-care ability can for example be discharged at an earlier time than a person with lower self-care ability, since the readmission risk of a patient with high self-care ability is lower.

In a variation of this embodiment, the instructions further cause the processor to use a risk model describing the risk of an adverse event and/or describing the risk of a deterioration of the patient's condition in view of the self-care ability of the patient and his social network.

In yet another embodiment of the healthcare system according to the present invention, the instructions further cause the processor to use patient data from an electronic health record. Patient information is often stored in form of an electronic health record. For a further refined care plan, the information from the electronic health record can be taken into account in addition to the patient activity data and social support activity data for evidence-based decision support.

### BRIEF DESCRIPTION OF THE DRAWINGS

These and other aspects of the invention will be apparent from and elucidated with reference to the embodiments described hereinafter. In the following drawings

FIG. 1 shows a schematic diagram of a first embodiment of the proposed healthcare system,

FIG. 2 shows a flow chart of a first embodiment of the proposed healthcare method,

FIG. 3 shows an exemplary embodiment of the proposed healthcare system in a clinical setting,

FIG. 4 shows a schematic diagram of a second embodiment of the proposed healthcare system for a clinical setting,

FIG. 5 shows a screen view of a readmission risk model according to the prior art,

FIG. 6 shows a schematic diagram of an embodiment of the proposed healthcare system for home settings.

### DETAILED DESCRIPTION OF THE INVENTION

The proposed healthcare system utilizes both patient activity data and social support activity data to compute recommendations for a care plan. This is a significant difference with respect to prior art implementations which rely on patient data only. This approach enables an evidence-based assessment of the self-care ability of the patient and the self-care ability of the social network. The output of the healthcare system according to the present invention is a care plan based on the obtained objective data.

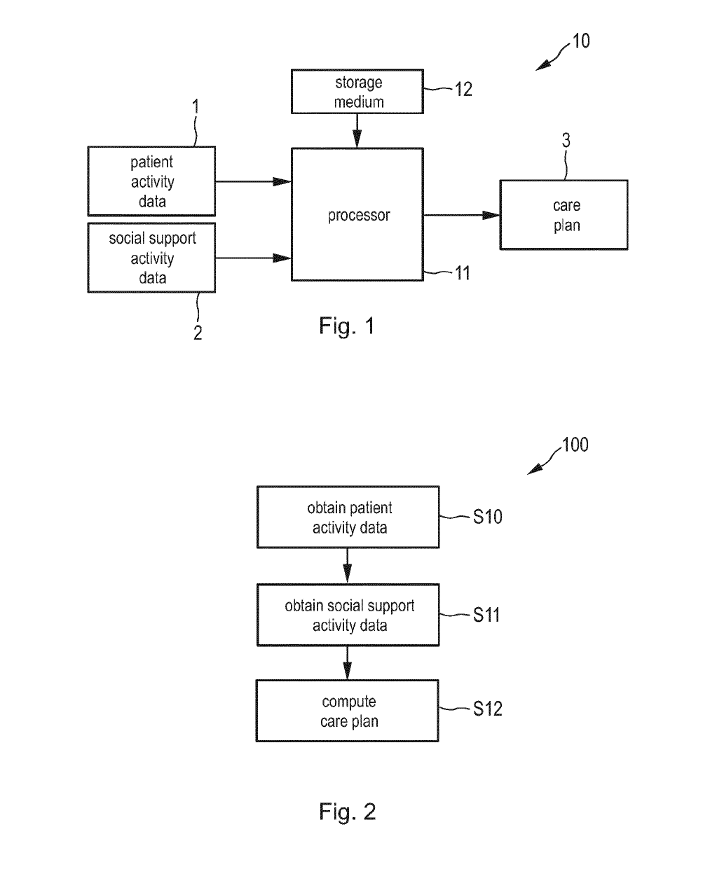

FIG. 1 shows a schematic diagram of a first embodiment of a healthcare system 10 according to the present invention. It comprises a processor 11 and a computer-readable storage medium 12. The computer-readable storage medium 12 contains instructions for execution by the processor 11. These instructions cause the processor 11 to perform the steps of a clinical support method 100 as illustrated in the flow chart shown in FIG. 2.

In a first step S10, patient activity data 1 descriptive of a physical activity of a patient, for whom a recommendation for a care plan shall be provided, is obtained. In a second step S11, social support activity data 2 descriptive of a level of interaction of the patient's social network with the patient is obtained. This data indicates the support and care the patient can receive from their social network. In a third step S12, recommendations for a care plan for the patient are computed based on the patient activity data 1 and the social support activity data 2. Alternatively, the sequence of steps S10 and S11 can be switched.

In an embodiment the care plan is continuously updated and adjusted to the patient's current needs and abilities. Thus, the care plan is not a static care plan. Therefore, the sequence of steps S10, S11, S12 can be repeated. Alternatively, the care plan can be updated if at least one of new patient activity data 1 and new social support activity data 2 is available.

Patient activity data is descriptive of a physical activity of a patient for whom a recommendation for care plan shall be provided. Preferably, the patient activity data is obtained from a sensor such as a movement sensor, GPS sensor, acceleration sensor, radar sensor, or a camera operating in the visible or infrared part of the spectrum. However, the source for obtaining patient activity data is not limited to any specific type of sensor. Alternatively, the physical activity data of the patient can be provided in an examination which may also include exercises such as a stress test on a thread mill or data from other fitness devices.

The social support activity data is descriptive of a level of interaction of the patient's social network with the patient. In a preferred embodiment, the level of interaction is descriptive of a level of physical interaction or a physical activity of at least one person in the patient's social network. Based on the patient activity data and the social support activity data the overall self-care ability of the patient and the self-care ability of the patient's social network can be estimated. These estimations are taken into account for the computation of recommendations for a tailored care plan for the patient.

The patient activity and the presence of a partner, family, friends and other social support are important for a proper self-care. Sufficient physical activity is often included in the discharge instruction and care plan for a patient. Hence, measured activity levels contribute to an overview of the health status of the patient. On the other hand, the detection of lower activity levels may signal even more important aspects, such as an increased frailty, depression or overall reduced self-care ability. A patient with reduced self-care ability may have trouble with food preparation, eating, washing, and other household tasks as well as bodily hygiene and requires additional support from professional care givers.

In hospital, a reduced patient activity or a lack of movement of the patient may signal instability, frailty, anxiety or depression. In hospital, a reduced social support activity or lack of movement signals from people in interaction with the patient may signal a limited mobility of the patient's social network, social isolation of the patient or even the lack of an informal care giver.

At home, a reduced patient activity or lack of movement of the patient may signal a deterioration of health, limited physical activity, depression, frailty or limited or reduced general self-care abilities. At home, a reduced social support activity or lack of movement from people in the patient's social network may signal social isolation of the patient and limited care support. In consequence, the healthcare system according to the present invention provides recommendations for a care plan that is tailored to the patient's needs and also takes the activity of their social network into account.

To a certain extent, a limited patient activity can be compensated by a strong activity of the social support network and equally a patient for whom a high level of physical activity has been detected does not require a high level of social support activity since he can take care of himself

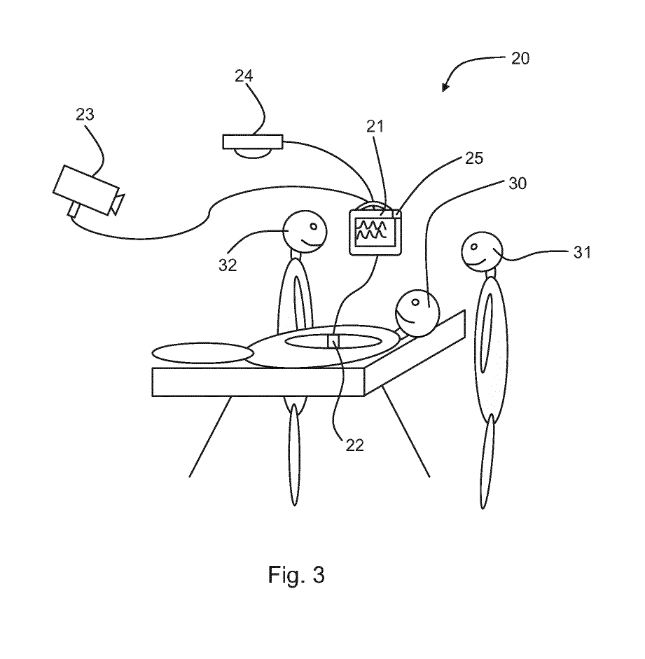

FIG. 3 shows an exemplary embodiment of the healthcare system in a clinical setting. In this embodiment, the healthcare system 20 is implemented by a patient monitor 21 with processor and computer-readable storage medium, an accelerometer 22 worn by the patient 30, a camera 23 and a movement sensor 24. Thus, the patient room is equipped with sensors 23, 24 that can measure the general activity in the room surrounding the bed and can measure the presence of the patient 30 in the bed and/or in a seat at the bedside. The sensors 22, 23, 24 are connected wired or wirelessly to the patient monitor 21. Patient activity data, descriptive of a physical activity of the patient, is obtained from the accelerometer 22 that is worn by the patient on his wrist. In FIG. 3, the patient 30 is bedridden such that the obtained patient activity data indicates a low level of physical activity of the patient 30. In addition to the patient 30, a nurse 31 and a visitor 32 are present in the room.

An embodiment of the healthcare system 20 in a non-clinical environment, for example at the patient's home, can comprise similar and/or identical sensors 22, 23, 24 or at least one alternative sensor.

In an embodiment with a patient specific sensor, such as an acceleration sensor 22, and a general environmental sensor, such as a motion sensor 24 or camera 23, the measured environmental data can be matched with the on-body or patient specific sensor to distinguish between patient activity data and activity from others. Again the activity can be corrected using the patient's schedule.

The patient monitor 21 further comprises an interface 25 for wired or wireless connection to the hospital network. Via this interface, the healthcare system 20 has access to the patient schedule. Since the patient schedule indicates that a nurse is present in the patient room, the social support activity data can be corrected. In the shown example, the camera 23 identifies two people 31, 32 in addition to the patient 30. However, the social support activity data should be corrected, because there is only one visitor 32. The nurse 31, being part of the professional care givers, does not count towards an interaction of the patient's social network with the patient 30. Hence, the social support activity data can be corrected to the activity of one visitor.

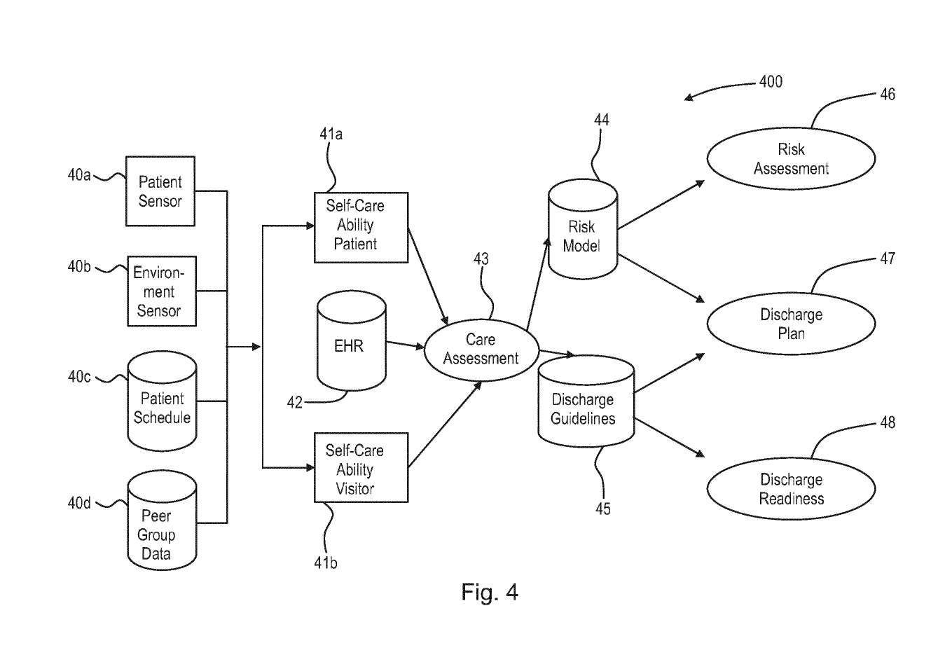

The operation of a healthcare system 400 for the hospital situation is described in more detail with reference to FIG. 4.

In a first step, the self-care ability of the patient 41a is computed. With an environmental sensor 40b, the number of active minutes for the patient is estimated by measuring the time when the patient is not in bed or in the chair in the room. Based on data in the hospital's electronic system that comprises the patient schedule 40c, these measures are corrected with the time spent on procedures away from the room like echoes or cath procedures (which reflects diagnostic and interventional procedures such as the placement of a stent in the arteries). The measured activity minutes are optionally compared with a peer group using historic measurements that are represented by the peer group data 40d. By comparing the patient's activity data with data from similar patients, a relative score on the self-care ability is computed based on the physical activity of the patient.

The self-care ability of the patient can optionally comprise measurements from a patient sensor 40a such as an on-body sensor like an accelerometer 22. This patient sensor 40a measures the physical activity of the patient during the hospital stay. This results in an absolute activity level, e.g. expressed in kilocalories expended on physical activity. A high level of physical activity indicates a high level of self-care ability of the patient. Furthermore, on a periodical basis, e.g. daily, the activity level is optionally compared with patients in a peer group 40d in the same phase of the hospitalization. A self-care ability score of the patient can be related to the average level of activity in hospital, in particular for patients in the same situation.

The self-care ability of the patient's social network, in this context denoted as the self-care ability of visitors, is determined in 41b. The environmental sensor 40b, such as a camera 23 or movement sensor 24, can detect the presence of visitors in the room. Preferably, the number of visitors is detected for example by means of a signal processing unit that analyzes a video stream from the camera 23. Alternatively, an infrared image of the room can be analyzed. Using this analysis, the presence of persons in the room in interaction with the patient is detected. The patient schedule 40c indicates the visiting hours such that the social support activity can be corrected and/or augmented. On a periodical basis, the number of visitor minutes is calculated. For example, two persons visiting for half an hour represent 60 visitor minutes. This number of visitor minutes can be related to the average number of visitor minutes derived from the peer group data 40d. A high number of visitor minutes indicates an active social network and hence indicates a strong self-care ability of the social network. The absolute and relative amount of self-care ability from the social network can be anticipated from the obtained data.

The overall level of care is assessed in the care assessment 43. The care assessment 43 is based on the self-care ability of the patient 41a, the self-care ability of the visitors 41b and optionally comprises the electronic health record (EHR) 42 of the patient.

The healthcare system 400 can further assess a discharge readiness 48. The discharge readiness 48 is derived from discharge guidelines 45 that have been created to define a state when it is safe to discharge the patient. Whether the criteria in these guidelines 45 have been met is based on elements present in the electronic health record (EHR) 42 and can be seen as a minimal requirement to discharge the patient. However, the recommendation for an exact discharge date is determined by including the computed self-care ability from the care assessment 43 that comprises the self-care ability of the patient 41a in the self-care ability of the patient's social network 41b. The combined amount of self-care ability of the patient and his social network decrease a period between meeting the minimal requirements for discharge and the recommended moment for discharge. In an embodiment, the instructions stored in the computer-readable storage medium cause the processor to perform a calculation wherein the period until discharge is increased when the two factors self-care ability of the patient 41a and self-care ability of the visitors 41b decrease. When the calculated period until discharge exceeds a predetermined threshold, for example the patient cannot be held in hospital for more than 72 hours after meeting the minimal discharge requirements, the recommendation for a discharge plan 47 is accompanied by a warning signaling the need for a proper transition, for example an intermediate skilled nursing facility since only insufficient self-care ability is anticipated at the moment of discharge.

Optionally, the healthcare system 400 can perform a risk assessment 46 based on a risk models 44. To compute a risk of an adverse event or early readmission, a number of observation or studies have been conducted. There are various known models that could be used, for instance admission risk models (e.g. a home risk model as e.g. described in Murata G H, Gorby M S, Kapsner C O, Chick T W, Halperin A K, “A multivariate model for predicting hospital admissions for patients with decompensated chronic obstructive pulmonary disease”, Arch Intern Med. 1992, January; 152(1):82-6), disease severity/diagnosis models (as e.g. described in Richard W Troughton, Christopher M Frampton, Timothy G Yandle, Eric A Espine, M Gary Nicholls, A Mark Richards, “Treatment of heart failure guided by plasma aminoterminal brain natriuretic peptide {(N-BNP)} concentrations”, The Lancet, Volume 355, Issue 9210, Pages 1126-1130, 1 Apr. 2000), or models on HF development such as HFSS (Heart Failure Severity Score) or Framingham Heart Failure model as e.g. described in Kannel W B, D'Agostino R B, Silbershatz H, Belanger A J, Wilson P W, Levy D, “Profile for estimating risk of heart failure”, Arch Intern Med. 1999 Jun. 14; 159(11):1197-204. Further, models predicting readmission and/or mortality risks can be used, including, but not limited to, those of described in Keenan P S, Normand S L, Lin Z, Drye E E, Bhat K R, Ross J S, Schuur J D, Stauffer B D, Bernheim S M, Epstein A J, Wang Y, Herrin J, Chen J, Federer J J, Mattera J A, Wang Y, Krumholz H M, “An administrative claims measure suitable for profiling hospital performance on the basis of 30-day all-cause readmission rates among patients with heart failure”, Circ Cardiovasc Qual Outcomes. 2008 September; 1(1):29-37, Amarasingham R, Moore B J, Tabak Y P, Drazner M H, Clark C A, Zhang S, Reed W G, Swanson T S, Ma Y, Halm E A, “An automated model to identify heart failure patients at risk for 30-day readmission or death using electronic medical record data”, Med Care. 2010 November; 48(11):981-8, or Tabak Y P, Johannes R S, Silber J H, “Using automated clinical data for risk adjustment: development and validation of six disease-specific mortality predictive models for pay-for-performance”, Med Care. 2007 August; 45(8):789-805. The description of these models in the cited publications is herein incorporated by reference.

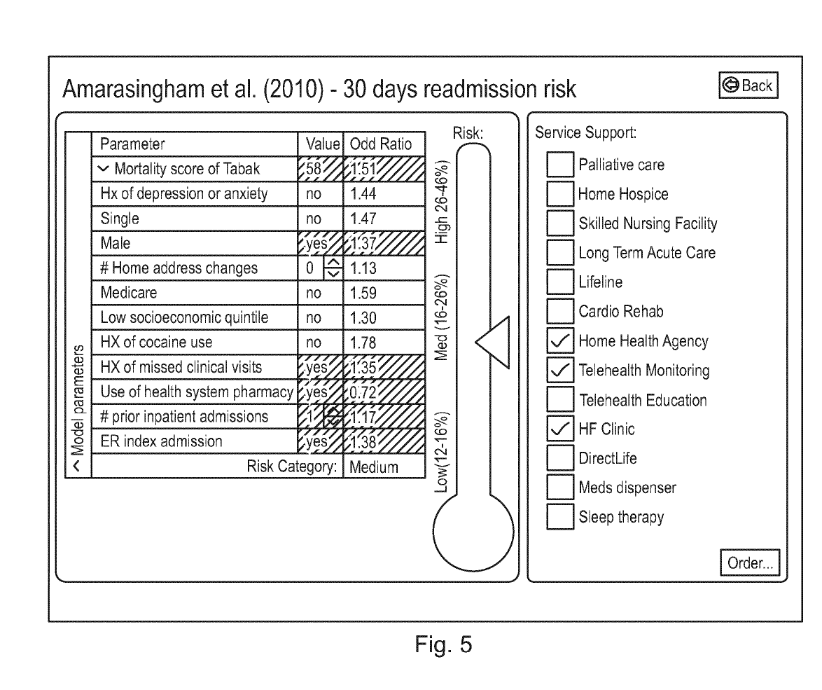

These models combine a number of patient parameters that can be obtained in the hospital setting. The focus of these models used to be on clinical parameters such as biomarkers and vital signs. However, psycho-social parameters also show to contribute to the prediction of early adverse events. The problem with depression, anxiety, care giver anxiety, care giver stress and other psycho-social predictors is that these are difficult to measure in an unobtrusive and objective manner. As an example, FIG. 5 shows the estimation of a 30-days readmission risk disclosed by Amarasingham et al. in the paper cited above.

In the healthcare system 400 according to the present invention the model by Amarasingham can be employed as a risk model 44. Since the target of the present invention are recommendations based on measureable data, the psycho-social parameters can be replaced by evidence-based measurements as follows: Firstly, the psycho-social parameters related to the patients themselves are replaced by the calculated self-care ability of the patient which is based on the obtained patient activity data descriptive of the physical activity of the patient. Secondly, the psycho-social parameters related to the care giver, partner or social contacts of the patient are replaced by the self-care ability of the social network of the patient. For example, the item “single” in FIG. 5 can be replaced by the social support activity. A single is more likely to suffer from social isolation. However, a single can also have a very active social life. The healthcare system according to the present invention provides measurable evidence in form of social support activity data. The determined risk from the risk model 44 can be used for risk assessment 46 by clinicians and can further be included in computing recommendations for a discharge plan 47 of the patient.

Finally, the healthcare system 400 provides recommendations for a discharge plan 47. The recommendations for the discharge plan 47 are calculated based on a combination of patient data from the electronic health record 42, the computed risk score from the risk model 44, the discharge guidelines 45 and the self-care ability of the patient 41a and the self-care ability of the patient's social network 41b.

The discharge plan 47 can be created using a rule-based algorithm wherein the aforementioned elements are combined to generate recommendations for a discharge plan. The discharge plan comprises a combination of follow-up appointments with medical professionals, home visits, programs such as cardiac rehab or smoking cessation classes and home services such as telehealth monitoring and meal service. In other words, by formulating rules that describe, for example, combinations of the patient's risk score, self-care ability of the social network and self-care ability of the patient himself, the discharge plan elements are recommended. Hence, a care plan is generated based on factual evidence.

As an example, a medium risk patient who is not able to cook and single and has limited support from his social network is assigned meal support as a professional service that cannot be provided by his social network. On the other hand, a patient with a very active social background can be assigned a reduced level of professional care since informal care givers already take good care of him.

In an alternative embodiment, the discharge plan 47 is created using a learning algorithm wherein the elements for the discharge plan 47 are suggested based on the combination of the self-care ability levels 41a, 41b, the risk score from the risk model 44 and the profile of the patient extracted from the electronic health record 42. Using a combination of past profiles and discharge plans, corresponding discharge plan elements for future patients are offered as a decision support to the responsible clinician.

While FIG. 3 has shown the healthcare system 20 in a hospital setting, the system can also be implemented at home. For example, the living room and/or kitchen can be equipped with a movement sensor 24. Alternatively, an activity can be monitored with additional sensors including a wearable sensor such as an accelerometer worn by the patient. Further types of sensors such as door sensors from an alarm system can also be incorporated.

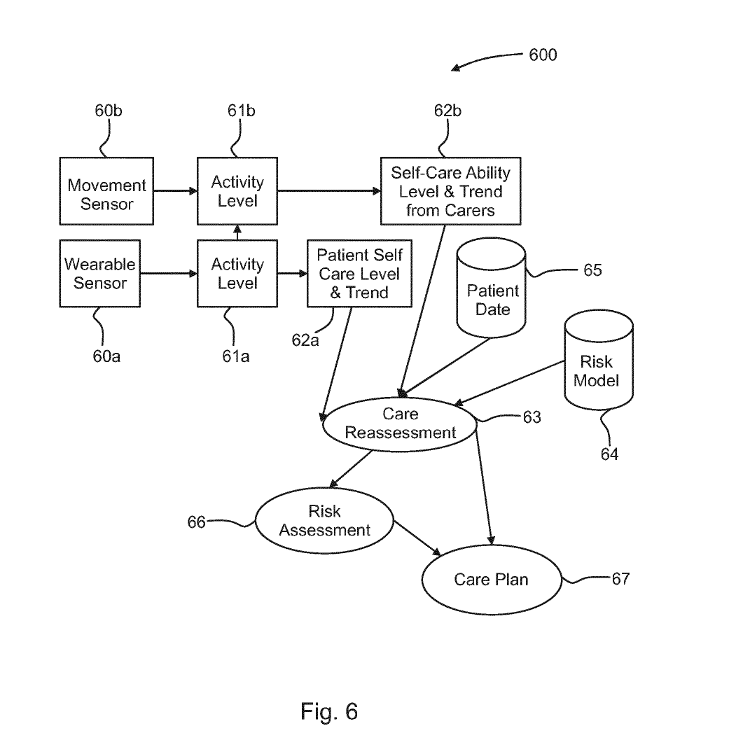

FIG. 6 shows an embodiment of a healthcare system 600 for a home situation. Of course, several aspects of the system can also be applied to a hospital scenario and vice versa.

The system comprises a wearable sensor 60a that can be worn by the patient for obtaining patient activity data descriptive of a physical activity or activity level 61a of the patient. The system further comprises a movement sensor 60b, for example a camera or a motion sensor. The movement sensor 60b can be mounted for example in the living room of the patient's home for measuring a general activity in the living room. Optionally, the activity level 61a of the patient can be used to correct the general activity level 61b. In particular, the activity level 61a of the patient can be subtracted from the general activity level 61b to isolate the activity level of the environment of the patient which activity level then indicates the social support activity of the patient's social network.

In a modification of this embodiment, the healthcare system 600 in the home only comprises a movement sensor 60b to measure the activity, and hence also the self-care ability, of all people in the house together. In this embodiment, no distinction is required between cohabitants and visitors.

The activity level 61a of the patient is used to determine the self-care ability of the patient. The activity level 61b of persons in the patient's social network is used to determine a self-care ability of the patient's social network 62b. Apart from computing self-care ability levels for a patient and his careers, also tends over time are computed in 62a, 62b. These trends can be used to detect deteriorations in activity patterns of the patient and/or social network or a lack/reduction of self-care abilities from either the patient himself or his social network.

The care that is required for the patient is assessed in care assessment 63. Alternatively, this step can be understood as a care re-assessment 63 that updates and refines a level of care that has been assessed in the hospital setting in step 43 and provided to the patient in form of a discharge plan 47. The required or recommended care is assessed based on the self-care ability of the patient 62a, the self-care ability of the social network 62b and the patient data 65 as well as the risk model 64. Patient data 65 may include data about the patient in a similar fashion as the electronic health record 42. The risk assessment 66 can be performed on a regular basis using either similar risk models 44 as described in the hospital situation or risk models that are tailored to measurement in the home situation. Apart from the shown risk assessment models, a risk score can be computed using the trend in informal care giver self-care ability 62b and patient self-care ability 62a levels. If a decrease in these levels over time is revealed, then this leads to a higher risk score of an adverse event.

Generally, the risk model and the discharge guidelines are optional, but a data source is needed to reflect on the patient's condition. The E.H.R. is an obvious example of a carrier of such information.

The care plan 67 can be updated on a regular basis. The level of self-care ability of the patient 62a and informal care givers 62b as well as the computer risk score 66 are used on a periodical basis to update the care plan 67 for the patient. This care plan 67 has been initiated after the last discharge for hospital in form of a discharge plan 47. Alternatively, a new care plan 67 can be generated by the healthcare system 600 for the home setting.

Based on measurements of the patient and social support activity 61a, 61b, the care provided by professional care givers such as a general practitioner, community nurses and medical specialists can be increased when the risk increases and/or when patient activity and/or social support activity decrease and vice versa.

Additionally, a proper date or moment for meetings with professional caregivers can be selected. For meetings outside the house of the patient, moments in the week can be selected when the social support available to the patient is above a threshold. For visits to the patient, moments when the patient typically lacks support are identified.

Similar to the situation in the hospital, the suggested updated care plans can be derived using a rule-based, data-driven or self-learning approach.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A healthcare system comprising a processor and a computer-readable storage medium, wherein the computer-readable storage medium contains instructions for execution by the processor, wherein the instructions cause the processor to perform the steps of:
obtaining patient activity data descriptive of a physical activity of a patient, for whom a recommendation for a care plan shall be provided,
obtaining social support activity data descriptive of a level of interaction of the patient's social network with the patient, and
computing recommendations for a care plan for the patient based on the patient activity data and the social support activity data,
wherein the healthcare system further comprises
at least one sensor for monitoring the patient and/or for monitoring an environment of the patient and
a signal processing unit for extracting patient activity data and social support activity data from an output signal of the at least one sensor.

2. The healthcare system according to claim 1, wherein said level of interaction of the patient's social network with the patient is descriptive of a physical activity of at least one person in the patient's social network.

3. (canceled)

4. (canceled)

5. The healthcare system according to claim 1, wherein the instructions further cause the processor to correct and/or augment the patient activity data and/or social support activity data based on the schedule of the patient.

6. The healthcare system according to claim 1, wherein the instructions further cause the processor to compute a relative patient activity and/or relative social support activity by comparing the patient activity data and/or social support activity data of the patient with patient activity data and/or social support activity data from other patients.

7. The healthcare system according to claim 1, wherein the instructions further cause the processor to dynamically update said recommendations for the care plan based on obtained patient activity data and/or social support activity data.

8. The healthcare system according to claim 1, wherein the instructions further cause the processor to compute said recommendations for the care plan based on a trend of obtained patient activity data and/or social support activity data over time.

9. The healthcare system according to claim 1, wherein the instructions further cause the processor to increase the recommended level of care for the patient if the patient activity data indicates a decreased patient activity and/or if the social support activity data indicates a decreased social support activity.

10. The healthcare system according to claim 1, wherein the instructions further cause the processor to recommend the scheduling of medical follow-up meetings at times when the patient is known to have a level of social support above a threshold available to him.

11. The healthcare system according to claim 1, wherein the instructions further cause the processor to use a discharge readiness model describing the readiness of the patient for discharge.

12. The healthcare system according to claim 1, wherein the instructions further cause the processor to use a risk model describing the risk of an adverse event and/or describing the risk of a deterioration of the patient's condition

13. The healthcare system according to claim 1, wherein the instructions further cause the processor to use patient data from an electronic health record.

14. A healthcare method comprising the steps of
obtaining patient activity data descriptive of a physical activity of a patient, for whom a recommendation for a care plan shall be provided,
obtaining social support activity data descriptive of a level of support the patient can receive from their social network, and
computing recommendations for a care plan for the patient based on the patient activity data and the social support activity data,
wherein patient activity data and social support activity data are extracted from an output signal of at least one sensor for monitoring the patient and/or for monitoring an environment of the patient.

15. A computer-readable non-transitory storage medium containing instructions for execution by a processor, wherein the instructions cause the processor to perform the steps of:
obtaining patient activity data descriptive of a physical activity of a patient, for whom a recommendation for a care plan shall be provided,
obtaining social support activity data descriptive of a level of support the patient can receive from their social network, and
computing recommendations for a care plan for the patient based on the patient activity data and the social support activity data,
wherein patient activity data and social support activity data are extracted from an output signal of at least one sensor for monitoring the patient and/or for monitoring an environment of the patient.

16. Computer program comprising program code means for causing a computer to carry out the steps of the method as claimed in claim 14 when said computer program is carried out on a computer.

17. A healthcare system comprising:
means for obtaining patient activity data descriptive of a physical activity of a patient, for whom a recommendation for a care plan shall be provided,
means for obtaining social support activity data descriptive of a level of support the patient can receive from their social network, and
means for computing recommendations for a care plan for the patient based on the patient activity data and the social support activity data,
wherein the healthcare system comprises,
at least one sensor for monitoring the patient and/or for monitoring an environment of the patient and
a signal processing unit for extracting patient activity data and social support activity data from an output signal of the at least one sensor.
